(19) United States
(12) Patent Application Publication
(10) Pub. No.: US 2026/0355991 A1
(43) Pub. Date: Nov. 12, 2026

(54) MOUNTING FRAME FOR RECIPROCATING SHAVER

(71) Applicant: Zhejiang Jingbo Hardware Technology Co., Ltd., Lishui (CN)

(72) Inventors: Bingjie JIN, Lishui (CN); Zhijian JIN, Lishui (CN)

(21) Appl. No.: 19/728,615

(22) Filed: Jul. 2, 2026

(30) Foreign Application Priority Data
Jul. 9, 2025 (CN) 202521431070.2

(51) Int. Cl. B26B 19/38; B26B 19/04

(52) U.S. Cl. CPC B26B 19/386; B26B 19/04

(57) ABSTRACT

A mounting frame for a reciprocating shaver, including a main body, a support arm located at an upper portion of the main body and configured to support a reciprocating cutter head, and plug structures located at a lower portion of the main body and configured to respectively engage with receiving channels on a handle housing. Each plug structure includes a slot plug protruding from a lower surface of the main body and a plug connector. The plug connector is fixed to the lower surface of the main body or to a lower portion of the slot plug, and extends downwardly for insertion into a corresponding receiving channel. The plug connector is provided with a locking portion for cooperating with a stopping part provided within the receiving channel. The plug connector is received within the receiving channel, and is positionable between a movement guide position and a locking position.

### CROSS-REFERENCE TO RELATED APPLICATIONS

This application claims the benefit of priority from Chinese Patent Application No. 202521431070.2, filed on Jul. 9, 2025. The content of the aforementioned application, including any intervening amendments thereto, is incorporated herein by reference in its entirety.

### TECHNICAL FIELD

This application relates to accessories of shavers for personal cleaning and care, and more particularly to a mounting frame for a cutter head of a reciprocating shaver.

### BACKGROUND

The existing commercially-available reciprocating shavers generally include a cutter head and a handle. The cutter head is pivotably connected to the handle such that it can rotate about an axis relative to the handle, thereby allowing the cutter head to follow contours of an object such as a user's face. A mounting frame is generally adopted to pivotably connect the cutter head to the handle. The existing mounting frames are generally equipped with full-groove plastic insertion pins for engagement with a handle housing. However, the plastic insertion pins are prone to breakage, and fails to provide sufficient structural strength and rigidity. In particular, the insertion pins protruding from the main body of the mounting frame are relatively fragile. Damage to the insertion pins may require replacement of the entire mounting frame equipped with a complex pivot assembly, even the entire shaver assembly, thereby increasing the use costs. In addition, for the manufacturers, it is required to design various molds to meet the production of plastic insertion pins of different specifications, resulting in increased production costs.

### SUMMARY

An object of the disclosure is to provide a mounting frame for a reciprocating shaver, which has excellent structural and supporting stabilities, and a simple manufacturing process, so as to overcome the defects in the prior art.

Technical solutions of the present disclosure are described as follows.

A mounting frame for a reciprocating shaver, the reciprocating shaver comprising a reciprocating cutter head and a handle housing, and the mounting frame comprising:
a main body;
a support arm located at an upper portion of the main body and configured to support the reciprocating cutter head; and
a plurality of plug structures located at a lower portion of the main body and configured to respectively engage with a plurality of receiving channels provided on the handle housing;
wherein each of the plurality of plug structures comprises a slot plug and a plug connector;
the slot plug is configured to protrude from a lower surface of the main body;
the plug connector is fixed to the lower surface of the main body or to a lower portion of the slot plug, and is configured to extend downwardly for insertion into a corresponding one of the plurality of receiving channels;
the plug connector is provided with a locking portion configured to cooperate with a stopping part provided within the corresponding one of the plurality of receiving channels;
the plug connector is received within the corresponding one of the plurality of receiving channels, and is positionable between a movement guide position and a locking position;
in the movement guide position, the plug connector is in a movable state, and is movable along the corresponding one of the plurality of receiving channels; and
in the locking position, the stopping part is configured to be retained by the locking portion, and the slot plug is configured to block an opening of the corresponding one of the plurality of receiving channels on a surface of the handle housing, thereby locking the main body to the handle housing.

In some embodiments, the plug connector is of a pin-type configuration.

In some embodiments, a free end of the plug connector is configured to be invertedly tapered.

In some embodiments, the plug connector is formed by two pins arranged in parallel at a fixed spacing;
the fixed spacing between the two pins is smaller than a width of the stopping part;
each of the two pins, along an insertion direction, is provided with a waist section, and a diameter of the waist section is smaller than diameters of two end portions of each of the two pins;
a minimum distance between two waist sections is greater than the width of the stopping part, thereby forming the locking portion between the two pins;
in the movement guide position, the stopping part is configured to abut against the two pins, and is movable relative to surfaces of the two pins; and
in the locking position, the stopping part is received within the locking portion, so as to restrict relative movement of the main body relative to the handle housing.

In some embodiments, the plug connector is a pin; and the pin, along an insertion direction, is provided with a waist section; and a diameter of the waist section is smaller than diameters of two end portions of the pin, so as to form a groove facing the stopping part as the locking portion.

In some embodiments, the plug connector is a bent strip part with two ends fixed to the lower surface of the main body or to the lower portion of the slot plug;
the plug connector comprises two vertical guide extending downwardly and a U-shaped connecting portion; a first end of each of the two vertical guide portions is fixed to the slot plug; and second ends of the two vertical guide portions are respectively connected to two ends of the U-shaped connecting portion;
the U-shaped connecting portion is configured to be bent toward the stopping part to form a hook as the locking portion; and
in the locking position, the stopping part is configured to be hooked and retained on the locking portion.

In some embodiments, the plug connector is formed by a first strip part and a second strip part arranged opposite to each other below the slot plug;
an end portion of the first strip part is bent toward the second strip part, and a free end of the first strip part is arranged spaced apart from a free end of the second strip part, so as to form a gap as the locking portion; and
in the locking position, the stopping part is received within the locking portion so as to restrict movement of the main body relative to the handle housing.

In some embodiments, the plug connector is an insertion post having a bent portion at an end thereof;
the bent portion is configured to be bent toward the stopping part so as to form a hook as the locking portion; and
in the locking position, the stopping part is hooked and retained on the locking portion.

Compared to the prior art, the present disclosure has the following beneficial effects.

The mounting frame adopts an upper-and-lower functional partition structure. An upper portion of the mounting frame is connected to a cutter head, and a lower portion of the main body of the mounting frame is supported through a plurality of corresponding plug structures. The plug structures employ slot plugs protruding by a short distance to block openings of a handle housing, thereby positioning the mounting frame on the handle housing and effectively ensuring stability and balance of the mounting frame after assembly. Meanwhile, locking at an installed position is achieved through cooperation between the plug connectors and locking portions provided on the plug connectors with stopping parts provided within the receiving channels. Since the functions of the plug structures are separated, material requirements for the plug connectors are reduced. In particular, the plug connectors and the main body are not integrally formed, such that the plug connectors may be made of a metallic material different from that of the slot plugs and having high wear resistance and rigidity. Moreover, the metallic plug connectors may be formed by stamping and bending during manufacture, thereby reducing manufacturing costs, significantly reducing the number of molds required, greatly improving universality, compatibility, and service life of the mounting frame, and facilitating maintenance and adjustment.

### BRIEF DESCRIPTION OF THE DRAWINGS

FIG. 1 is a structural view of a mounting frame for a reciprocating shaver according to a first embodiment of the present disclosure;

FIG. 2 is a structural view showing the mounting frame of FIG. 1 mounted on a handle housing in a locking position;

FIG. 3 is a structural view of a mounting frame for a reciprocating shaver according to a second embodiment of the present disclosure;

FIG. 4 is a structural view showing the mounting frame of FIG. 3 mounted on a handle housing in a locking position;

FIG. 5 is a structural view of a mounting frame for a reciprocating shaver according to a third embodiment of the present disclosure;

FIG. 6 is a structural view showing the mounting frame of FIG. 5 mounted on a handle housing in a locking position;

FIG. 7 is a structural view of a mounting frame for a reciprocating shaver according to a fourth embodiment of the present disclosure;

FIG. 8 is a structural view showing the mounting frame of FIG. 7 mounted on a handle housing in a locking position;

FIG. 9 is a structural view of a mounting frame for a reciprocating shaver according to a fifth embodiment of the present disclosure; and

FIG. 10 is a structural view showing the mounting frame of FIG. 9 mounted on a handle housing in a locking position.

### DETAILED DESCRIPTION OF EMBODIMENTS

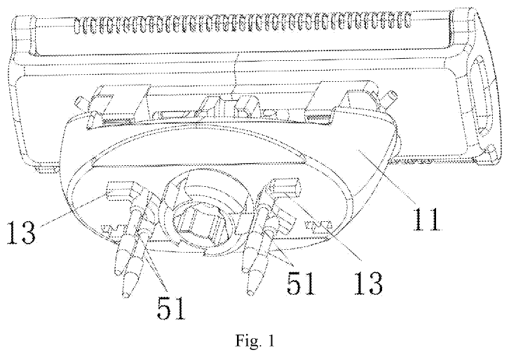

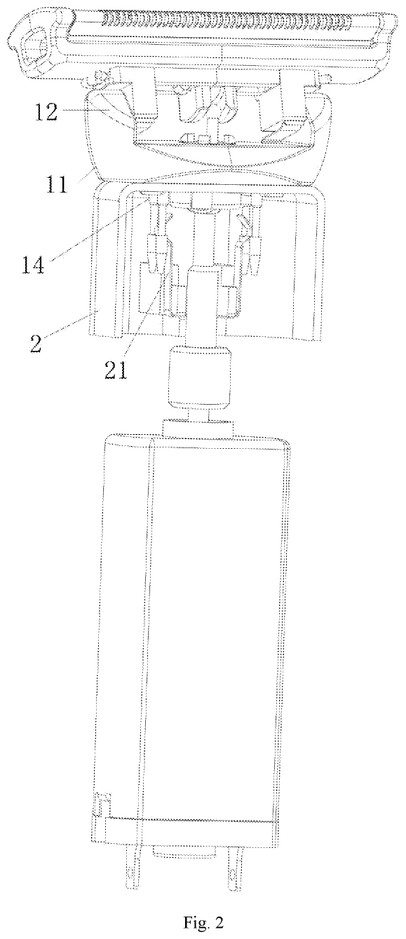

As shown in FIGS. 1-2, an embodiment of the present disclosure provides a mounting frame for a reciprocating shaver, including a main body 11, a support arm 12 located at an upper portion of the main body 11 and configured to support a reciprocating cutter head, and two plug structures located at a lower portion of the main body 11 and configured to engaged with receiving channels provided on a handle housing 2 (not labeled in the figures). The two plug structures are provided opposite to each other. Each plug structure includes a slot plug 13 protruding from a lower surface of the main body 11, and a plug connector 14 fixed to the lower surface of the main body 11 or to a lower portion of the slot plug 13 and extending downwardly for insertion into a corresponding receiving channel. A protruding height of the slot plug 13 does not need to be excessively large so as to avoid breakage. An outer contour of the slot plug 13 only needs to correspond to a slot opening to achieve blocking and positioning. After locking, the plug connector fixedly connects the mounting frame to a handle through a stable portal-frame support structure. The plug connector 14 is provided with a locking portion configured to cooperate with a stopping part 21 provided within the corresponding receiving channel. The stopping part 21 is formed by bending a spring plate, and is provided with a V-shaped limiting buckle to facilitate locking and unlocking. The plug connector 14 is received within the corresponding receiving channel, and is positionable between a movement guide position and a locking position. In the movement guide position, the plug connector 14 is in a movable state, and is movable along the corresponding receiving channel. In the locking position, the stopping part 21 is configured to be retained by the locking portion. At this time, the slot plug 13 is configured to block an opening of the corresponding receiving channel on a surface of the handle housing 2, thereby locking the main body 11 to the handle housing 2. The plug connector 14 is made of a metallic material having a certain degree of rigidity and hardness. Five specific implementations of the plug structures are exemplified below to form plug connectors and locking portions corresponding to the stopping part 21.

As shown in FIGS. 1-2, in a first embodiment of the mounting frame for the reciprocating shaver, the plug connector 14 is of a pin-type configuration. In order to facilitate a smoother insertion operation, a free end of the plug connector in this embodiment is configured to be invertedly tapered so as to guide the stopping part 21 into the locking portion. The plug connector 14 is formed by two pins arranged in parallel at a fixed spacing. The fixed spacing between the two pins is smaller than a width of the stopping part 21. Each pin, along an insertion direction, is provided with a waist section 51, and a diameter of the waist section 51 is smaller than diameters of two end portions of each pin. A minimum distance between two opposing waist sections 51 is greater than the width of the stopping part 21, thereby forming a widened locking portion between the two pins. In the movement guide position, the stopping part 21 is configured to abut against the two pins, and is movable relative to surfaces of the two pins. In the locking position, the stopping part 21 is received within the locking portion so as to restrict movement of the main body 11 relative to the handle housing 2.

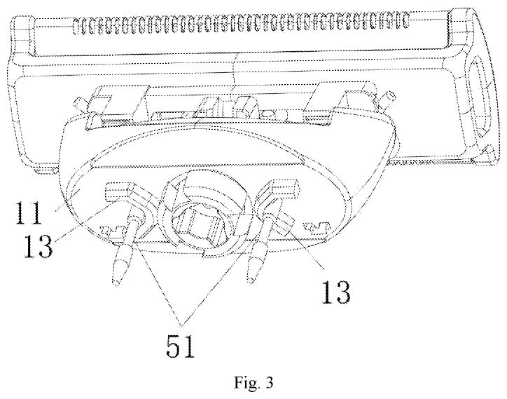

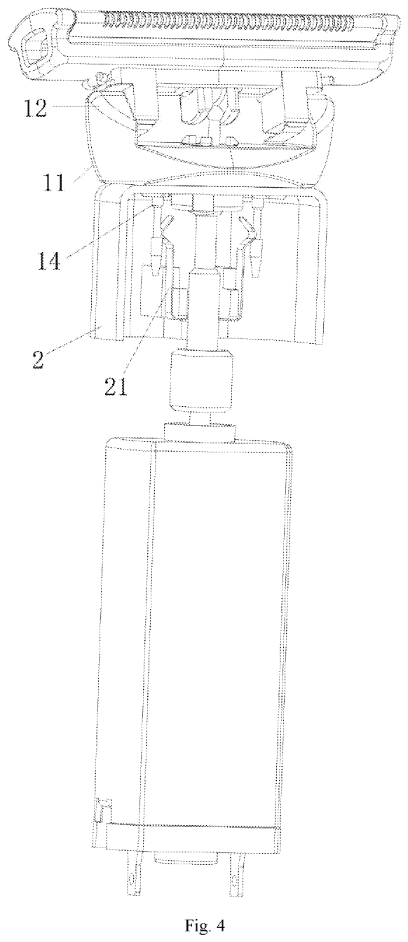

As shown in FIGS. 3-4, in a second embodiment of the mounting frame for the reciprocating shaver, the plug connector is a pin. In this embodiment, in order to ensure reliability of engagement, the pin is arranged at a position corresponding to a middle portion of the slot opening, although the pin may alternatively be slightly offset. In order to facilitate a smoother insertion operation, a free end of the plug connector in this embodiment is configured to be invertedly tapered so as to guide the stopping part 21 into the locking portion. The pin, along an insertion direction, is provided with the waist section 51. A diameter of the waist section is smaller than diameters of two end portions of the pin, so as to form a groove facing the stopping part 21 as the locking portion.

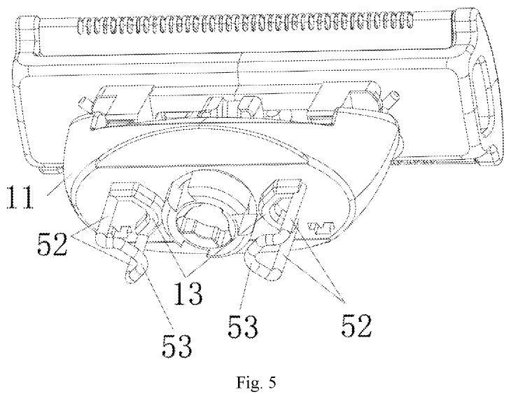

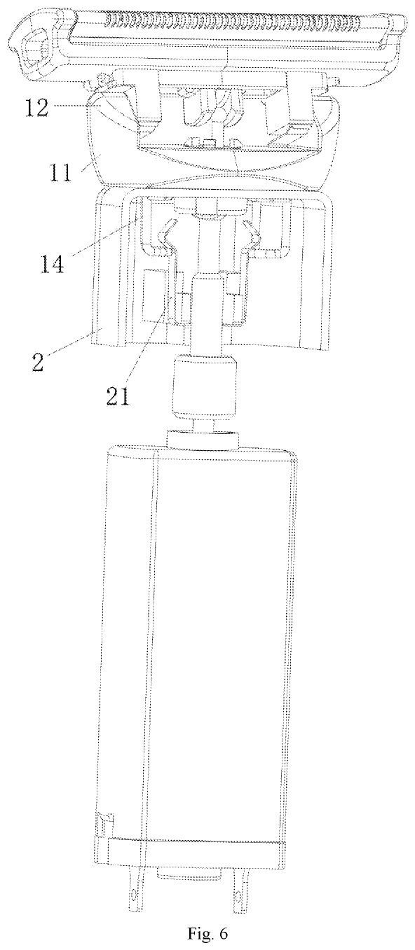

As shown in FIGS. 5-6, in a third embodiment of the mounting frame for the reciprocating shaver, the plug connector is a bent strip part, i.e., an elongated metal strip, having two ends fixed to the lower surface of the main body 11 or to the lower portion of the slot plug 13. The plug connector includes two vertical guide portions 52 extending downwardly and a U-shaped connecting portion 53. A first end of each of the two vertical guide portions 52 is fixed to the slot plug 13. Second ends of the two vertical guide portions 52 are respectively connected to two ends of the U-shaped connecting portion 53. The U-shaped connecting portion 53 is configured to be bent toward the stopping part 21 to form a hook as the locking portion. In the locking position, the stopping part 21 is configured to be hooked and retained by the locking portion. A projection of an outer contour of the locking portion on a cross section is completely enclosed within the slot opening, such that the locking portion is capable of smoothly passing through the slot opening into the corresponding receiving channel.

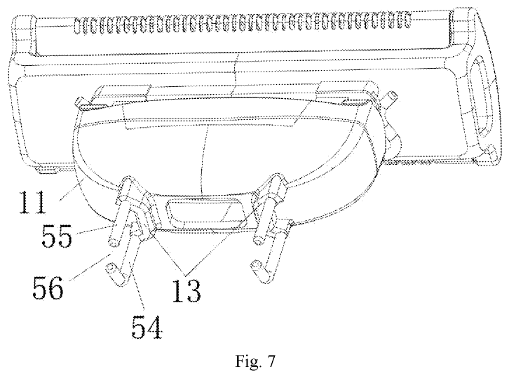

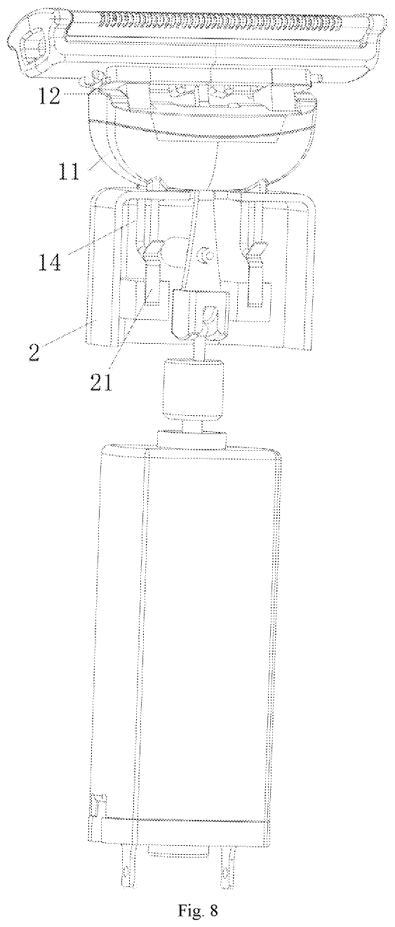

As shown in FIGS. 7-8, in a fourth embodiment of the mounting frame for the reciprocating shaver, the plug connector is formed by a first strip part 54 and a second strip part 55 arranged opposite to each other below the slot plug 13. An end portion of the first strip part 54 is bent toward the second strip part 55 in a non-closed manner to form a notch 56. A free end of the first strip part 54 is arranged spaced apart from a free end of the second strip part 55 so as to form a gap as the locking portion. In the locking position, the stopping part 21 is received within the locking portion so as to restrict movement of the main body relative to the handle housing.

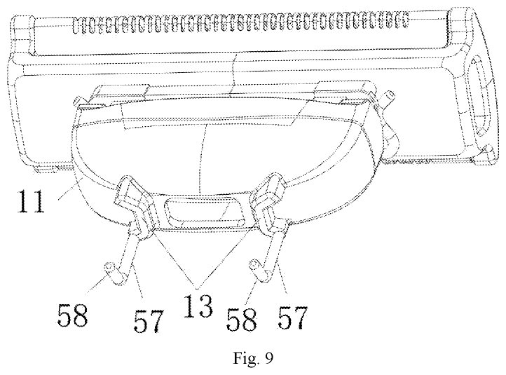

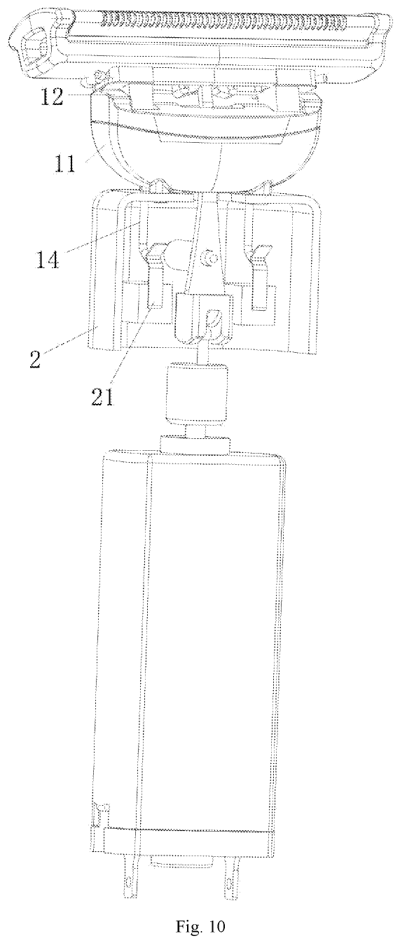

As shown in FIGS. 9-10, in a fifth embodiment of the mounting frame for the reciprocating shaver, the plug connector is an insertion post 57 having a bent portion 58 at an end thereof. The bent portion 58 is configured to be bent toward the stopping part 21 to form the hook as the locking portion. In the locking position, the stopping part 21 is hooked and retained on the locking portion.

The above embodiments are easy to implement and provide better wear resistance, a longer service life, and more convenient maintenance as compared with an integrally formed frame. In addition, the number of molds required by component manufacturers is greatly reduced.

Described above are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A mounting frame for a reciprocating shaver, the reciprocating shaver comprising a reciprocating cutter head and a handle housing, and the mounting frame comprising:
a main body;
a support arm located at an upper portion of the main body and configured to support the reciprocating cutter head; and
a plurality of plug structures located at a lower portion of the main body and configured to respectively engage with a plurality of receiving channels provided on the handle housing;
wherein each of the plurality of plug structures comprises a slot plug and a plug connector;
the slot plug is configured to protrude from a lower surface of the main body;
the plug connector is fixed to the lower surface of the main body or to a lower portion of the slot plug, and is configured to extend downwardly for insertion into a corresponding one of the plurality of receiving channels;
the plug connector is provided with a locking portion configured to cooperate with a stopping part provided within the corresponding one of the plurality of receiving channels;
the plug connector is received within the corresponding one of the plurality of receiving channels, and is positionable between a movement guide position and a locking position;
in the movement guide position, the plug connector is in a movable state, and is movable along the corresponding one of the plurality of receiving channels; and
in the locking position, the stopping part is configured to be retained by the locking portion, and the slot plug is configured to block an opening of the corresponding one of the plurality of receiving channels on a surface of the handle housing, thereby locking the main body to the handle housing.

2. The mounting frame of claim 1, wherein the plug connector is of a pin-type configuration.

3. The mounting frame of claim 2, wherein a free end of the plug connector is configured to be invertedly tapered.

4. The mounting frame of claim 2, wherein the plug connector is formed by two pins arranged in parallel at a fixed spacing;
the fixed spacing between the two pins is smaller than a width of the stopping part;
each of the two pins, along an insertion direction, is provided with a waist section, and a diameter of the waist section is smaller than diameters of two end portions of each of the two pins;
a minimum distance between two waist sections is greater than the width of the stopping part, thereby forming the locking portion between the two pins;
in the movement guide position, the stopping part is configured to abut against the two pins, and is movable relative to surfaces of the two pins; and
in the locking position, the stopping part is received within the locking portion, so as to restrict relative movement of the main body relative to the handle housing.

5. The mounting frame of claim 3, wherein the plug connector is formed by two pins arranged in parallel at a fixed spacing;
the fixed spacing between the two pins is smaller than a width of the stopping part;
each of the two pins, along an insertion direction, is provided with a waist section, and a diameter of the waist section is smaller than diameters of two end portions of each of the two pins;
a minimum distance between two waist sections is greater than the width of the stopping part, thereby forming the locking portion between the two pins;
in the movement guide position, the stopping part is configured to abut against the two pins, and is movable relative to surfaces of the two pins; and
in the locking position, the stopping part is received within the locking portion, so as to restrict relative movement of the main body relative to the handle housing.

6. The mounting frame of claim 2, wherein the plug connector is a pin; the pin, along an insertion direction, is provided with a waist section; and a diameter of the waist section is smaller than diameters of two end portions of the pin, so as to form a groove facing the stopping part as the locking portion.

7. The mounting frame of claim 3, wherein the plug connector is a pin; the pin, along an insertion direction, is provided with a waist section; and a diameter of the waist section is smaller than diameters of two end portions of the pin, so as to form a groove facing the stopping part as the locking portion.

8. The mounting frame of claim 1, wherein the plug connector is a bent strip part with two ends fixed to the lower surface of the main body or to the lower portion of the slot plug;
the plug connector comprises two vertical guide portions extending downwardly and a U-shaped connecting portion; a first end of each of the two vertical guide portions is fixed to the slot plug; and second ends of the two vertical guide portions are respectively connected to two ends of the U-shaped connecting portion;
the U-shaped connecting portion is configured to be bent toward the stopping part to form a hook as the locking portion; and
in the locking position, the stopping part is configured to be hooked and retained on the locking portion.

9. The mounting frame of claim 1, wherein the plug connector is formed by a first strip part and a second strip part arranged opposite to each other below the slot plug;
an end portion of the first strip part is bent toward the second strip part, and a free end of the first strip part is arranged spaced apart from a free end of the second strip part, so as to form a gap as the locking portion; and
in the locking position, the stopping part is received within the locking portion so as to restrict movement of the main body relative to the handle housing.

10. The mounting frame of claim 1, wherein the plug connector is an insertion post having a bent portion at an end thereof;
the bent portion is configured to be bent toward the stopping part so as to form a hook as the locking portion; and
in the locking position, the stopping part is hooked and retained on the locking portion.
